(19) United States
(12) Patent Application Publication
(10) Pub. No.: US 2009/0084512 A1
(43) Pub. Date: Apr. 2, 2009

(54) Process to produce substrate resistant to alkaline starch

(76) Inventor: Robert H. Moffett, Landenberg, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/906,356

(22) Filed: Oct. 2, 2007

(51) Int. Cl. D21H 19/00; B05D 3/02

(52) U.S. Cl. 162/112; 427/372.2; 427/384

(57) ABSTRACT

A process for producing a substrate having a surface that is resistant to adhesion of alkaline starch wherein a coating composition comprising a fluorosilicone and a solvent is applied to the surface of the substrate. The process is particularly applicable with substrates which are components of paper machines, such as paper corrugators. There is further provided an improved process for producing a corrugated paper wherein a coating composition comprising a fluorosilicone and a solvent is applied to the surface components of a paper corrugator.

### FIELD OF THE INVENTION

The present invention relates to a process for producing a substrate having a surface that is resistant to adhesion of alkaline starch.

### BACKGROUND OF THE INVENTION

Starch is a naturally occurring carbohydrate polymer found in numerous products such as corn, wheat, potatoes, rice, tapioca, and sago. When heated in water, starch adhesive molecules swell and eventually burst, a process known as gelation, resulting in a thickened, colloidal suspension. Dextrin is starch that has been process further and contains less water content and requires less drying time. Dextrin is used as an adhesive in the same applications as starch. For purposes of this invention, starch and dextrin are used interchangeably. The colloidal suspension makes an excellent adhesive. Indeed, starch is the main adhesive used in processes to produce paper products, including corrugated paper. Starch adhesives are frequently used as adhesives due to their relatively low cost of production, ready available, heat resistance when cured, and they are non-toxic.

Alkaline compounds, such as sodium hydroxide, are added to starch for gelation modification. Most starch-based adhesives made today contain alkaline compounds. Alkaline compounds are added to a starch solution prior to gelation to aid in lowering the gelation temperature to inhibits retrogradation. Retrogradation is the forming of crystalline aggregates from hydrogen bonding of the starch. Starch-based adhesives are heat-cured during application to surfaces. As used herein, “alkaline starch” includes alkaline starch-based adhesives.

Starch is used as an adhesive for industrial paper applications including, but are not limited to, fabrication of corrugated board, paper bags, paper boxes, laminated paperboard, spiral-wound tubes, gummed labels and tapes, wallpaper hanging plaster, binders, labeling of bottles and jars, envelope manufacture and book binding. Starch can be used in textiles for sizing of yarn and in pharmaceutical industries use it as a tablet binder. Starch is also used as a thickening agent or binder in food applications.

Corrugated paper is generally formed by corrugating a flat sheet of paper, for example, made on a Fourdrinier machine, by passing the flat sheet into a nip formed by two longitudinally toothed rolls rotating in a mesh to form a series of parallel flutes or corrugations in the sheet. The toothed rolls are called corrugator or corrugating rolls. The paper that is corrugated is called the “medium” or “corrugated medium”. One or both sides of the corrugated medium is bonded to flat sheets called “liners” or “facers” or “face sheet” by means of adhesive placed on tips or the outer ridges of the flutes or teeth of the medium or corrugated medium. In a single facer corrugating machine, a liner is applied to one side of the corrugated medium. Corrugated board that is bonded to a liner is called a single-faced corrugated board.

The corrugator rolls are normally heated to a temperature of about 320-380° F. (160-194° C.). The medium is normally heated to a temperature 300-380° F. (148-194° C.), before reaching the corrugator rolls in order to render the medium sufficiently pliable to mold and accept the corrugating stress without fracture or malformation of the flutes in the medium.

Starch is transferred to the tips of the corrugated medium during the corrugating process, to enable bonding of the liners. At high speeds, which are desirable for optimum productivity, starch tends to splash over equipment, including the corrugator rolls, causing starch to build up unevenly on surfaces. Starch may also enter surface imperfections of surfaces of paper rolls, such as, for example, extremely fine or “hairline” surface cracks that can cause surface chipping due to hardened starch as it expands in these crevices. Starch may adhere to and build up on roll surfaces causing the medium or liner or both to stick to the rolls resulting in wrapping paper around the rolls shutting down production.

In addition to starch, silicate-based adhesives have been used in corrugator processes. To prevent and/or minimize adhesion of silicate-based adhesive to corrugator components, Foster et al., in U.S. Pat. No. 3,076,773, disclose applying a coating composition comprising an alkylalkoxypolysiloxane, a benzene-soluble dimethylpolysiloxane and methylhydrogensiloxane.

Kane, in U.S. Pat. No. 3,103,459, discloses application of various types of lubricants, such as lubricating oil, wax or asphalt to corrugator rolls to address fracturing or rupturing of corrugator medium.

Substances such as hydrocarbon oil are often applied to roll surfaces during production to prevent adhesive from building up such as those described by Schoo, in U.S. Pat. No. 1,796,542; Shields, in U.S. Pat. No. 2,557,011; and Little, in U.S. Pat. No. 2,982,333. These substances volatilize and create a smoky and unsafe environment as heat is applied to the corrugator roll surfaces. Oil also carbonizes on the hot roll surfaces and is difficult to remove. If excessive amounts of oil are used, it can spatter on the paper causing unacceptable quality container board.

Silicone oils have been used as a coating in corrugated cardboard production with some success. Halsey, et al., in U.S. Patent Application 2005/0266166 discuss application of a silicone coating to paper roll and corrugated rolls. However, some starch adhesives prepared with alkali chemistry, such as in the Stein-hall process, attack and degrade the silicone coating allowing the starch adhesive to become adhered to the unprotected corrugating roll. This build up of starch stops production for cleaning and possible repair causing extended down time.

Therefore, there is a need for a process which provides improved surface-release of alkaline starch or a surface coating that is resistant to attack from alkaline starch adhesives, in order to prevent alkaline starch from adhering to and building up on surfaces. There is further needed a method for producing corrugated paper in which the problem of paper wrapping around paper rolls is prevent or at least reduced, in which alkaline starch is managed, in which downtime caused by the need to clean alkaline starch off corrugator rolls and other components of a paper machine are reduced, in which the need to reapply a starch-resistant coating is eliminated or the frequency of the need to reapply such coating to corrugator rolls and/or other components of a paper machine is reduced. The present invention meets these needs.

### SUMMARY OF THE INVENTION

The present invention provides a process for producing a substrate having a surface which is resistant to alkaline starch, comprising applying a coating composition which comprises a fluorosilicone and a solvent to the surface. The composition may further comprise a catalyst a non-fluorinated silicone and other additives. The coating composition can be in the form of a solution or a dispersion. The process may further comprise curing the coating. The process is especially useful when the substrate is one or more components of a paper machine in order to produce components of a paper machine that are resistant to adherence by alkaline starch. Preferably, the paper machine is a paper corrugator and the components of the paper machine are selected from the group consisting of corrugating rolls, paper rolls, drum dryer rolls, pressure rolls, conduits, and hot plates.

There is also provided an improved process for producing a corrugated paper on a paper corrugator comprising passing a first flat sheet of paper into a nip formed by two corrugator rolls rotating in a mesh to form a series of parallel flutes (corrugations) in the sheet to produce a corrugated medium, applying an alkaline starch-based adhesive to the outer ridges of the flutes of the corrugated medium, and bonding one or both sides of the corrugated sheet to a second or second and third flat sheet to produce corrugated board, wherein the improvement comprises applying a coating composition which comprises a fluorosilicone, a solvent, and a catalyst to the surface of the corrugator rolls prior to passing the first flat sheet into the nip.

### DETAILED DESCRIPTION OF THE INVENTION

Herein tradenames are shown in capital letters.

The present invention is a process for producing a substrate having a surface which is resistant to alkaline starch, which comprises applying a coating composition comprising a fluorosilicone and a solvent to the surface. Optionally, the process further comprises curing the coating. The product of such a process is a substrate having a surface coated with a fluorosilicone compound. The substrate is resistant to degradation of the coating and of the surface when contacted with alkaline starch, such as alkaline starch-based adhesives.

By a surface which is “resistant to alkaline starch” means herein that a surface produced according to the process of this invention will resist adherence thereto by alkaline starch and alkaline starch-based adhesives; that build up of alkaline starch on the surface is reduced and/or eliminated under conditions in which the surface is exposed to alkaline starch, relative to untreated or prior art treated surfaces; that the surface coating produced in the process of this invention is resistant to attack from alkaline starch, under conditions in which the surface is exposed to alkaline starch and when other known surface coatings are worn away or eroded under similar conditions. The present invention provides a further benefit of eliminating or reducing the frequency of reapplying a coating to the surface due to the durability of the surface treated according to this invention compared to other surface treatments.

The term “coating composition” can also be referred to as “surface release composition”. The coating composition can be in the form of a solution or a dispersion. For example, when water is used as a solvent, the composition is generally in the form of a dispersion.

The term “substrate” can refer to metal, glass, ceramic tile, brick, concrete, wood, masonry, fiber, leather, plastics, or stone. Frequently the substrate is metal. Examples of metal substrates include, but are not limited to, metal molds which are shape-determining surfaces, paper rolls, drum dryer rolls, corrugator rolls, pressure rolls, conduits, hot plates, fan blades, chain links and mold plates.

The term “surface” means not only an exterior surface, but also an interior surface if the substrate is a conduit such as tubing, hose, pipe, or nozzle. The application disclosed herein illustrates coating of the surface of corrugator rolls, but the coating composition and the process of coating can be applied to other substrates, such as those disclosed above.

In a particular embodiment, the substrate is one or more components of a paper machine. By “paper machine” it is meant to include both a machine that manufactures paper, such as a Fourdrinier machine, as well as a machine that processes paper, such as a paper corrugating machine, also referred to as a paper corrugator. Examples of components of a paper machine having a surface suitable for coating with the composition include but are not limited to, paper rolls, such as, for example, wet end rolls, table rolls, couch rolls and press rolls, dryer cans, and drum dryer rolls. A combination of two or more components may be coated.

Examples of components of a paper corrugator having a surface suitable for coating with the composition include, but are not limited to, paper rolls, corrugator rolls, pressure rolls, corrugator pressure belts, Double Backer hot plate/mesh plates, ink pans and glue pans.

Preferably, according to the method of this invention, the composition is applied to the cleaned surface of paper roll, drum dryer roll, corrugator roll, pressure roll, corrugator pressure belt, Double Backer hot plate/mesh plate, glue pan and combination of two or more thereof. More preferably, the composition is applied to the surface of one or more of paper roll, drum dryer roll, corrugator roll, and combination of two or more thereof. Most preferably, the composition is applied to corrugator rolls.

### Fluorosilicones

The coating composition of this invention comprises a fluorosilicone. The fluorosilicone is a siloxane copolymer comprising at least one fluorinated alkyl group. Such fluorosilicones are known in the art and are generally available commercially, for example, from Dow Corning, Midland, Mich. and General Electric Company, Fairfield, Conn. The fluorosilicones also can be produced by any methods known to one skilled in the art. For example, the fluorosilicone can have the structure of R¹[(Si(R¹)₂O]ₐ[Si(R¹)(R²Rf)O]_{b}[Si(R¹)₂O]_{c}Si(R¹)₃ where a, b, and c is each independently 1 to 100. Each R¹ is independently selected from the group consisting of hydrogen, alkyl, oxyalkyl, alkenyl, aryl and oxyaryl. The alkyl, oxyalkyl, and alkenyl groups have 1 to 8 carbon atoms. When R¹ is alkyl, oxyalkyl or alkenyl group, the group can be linear or branched. R¹ may be, for example, methyl, methoxy, ethyl, ethoxy, phenyl, phenoxy, ethenyl (—C₂H₃) or propenyl (—C₃H₅).

R² is a linking alkylene group (divalent group) having at least 2 carbon atoms. R² may be, for example, —CH₂CH₂— or —CH₂CH₂CH₂—.

Rf is a fluorinated alkyl having 1 to 8 carbon atoms or a fluorinated aryl. Rf may contain hydrogen atoms; that is, Rf need not be perfluorinated. When Rf is a fluorinated alkyl, it may be linear or branched. Rf may be, for example, trifluoromethyl, pentafluoroethyl, pentafluorophenyl, 6-hydroperfluorohexyl and tridecafluorohexyl.

The coating composition typically comprises 0.5 to 10% by weight of the fluorosilicone, based on the total weight of the coating composition. Preferably, the coating composition comprises 1 to 5% by weight of fluorosilicone. More preferably, the coating composition comprises 2 to 3% by weight of fluorosilicone.

### Solvents

The composition comprises a solvent. Any volatile compound that does not adversely react with other components in the coating composition can be used. The solvent can be used for example, to lower the viscosity of the coating to aid in application of the coating composition. The solvent can be used to lower the viscosity sufficiently to enable the coating composition to be sprayed onto the surface of the substrate. The solvent can be or comprise an alkane, ketone, ester, ether, alcohol or combination of two or more thereof. More specifically, the solvent can be or comprise such as, for example, n-heptane, octane, cyclohexane, dodecane, acetone, methyl ethyl ketone, methyl isobutyl ketone, diisobutyl ketone and combination of two or more thereof.

The solvent can also be or comprise water. In the event water is used as the solvent or as a component of the solvent, it is advantageous to add an emulsifier.

The solvent can also be or comprise a volatile siloxane. The term “volatile siloxane” refers to a rapidly evaporating siloxane under the temperature and pressure of use. Typically, it can have an evaporation rate of more than 0.01 relative to n-butyl acetate which has an assigned value of 1. A volatile siloxane can have the formula of R⁴(R⁴₂SiO)ₓSiR⁴₃ or (R⁴₂SiO)_{y} where each R⁴ is independently an alkyl group or an alkoxy group, a phenyl group, a phenoxy group, or combination of two or more thereof. Suitable alkyl groups and alkoxy groups have 1 to about 10 or preferably, 1 to about 8 carbon atoms per group. R⁴ can also be substituted alkyl group, such as an alkyl group having halogen, amine or other functional group substituent. R⁴ can also be a halogen. Subscript x is a number from about 1 to about 20 or from about 1 to about 10 and y is a number from about 3 to about 20 or from about 3 to about 10. Such volatile siloxanes have a molecular weight in the range of from about 50 and to about 1,000 and a boiling point less than about 300° C., preferably less than 250° C., more preferably less than 200° C., and most preferably less than 150° C.

Examples of suitable methyl siloxanes include, but are not limited to, hexamethyldisiloxane, hexamethylcyclotrisiloxane, 2,5-dichloro-1,1,3,3,5,5,-hexamethyltrisiloxane, 1,3-dimethyltetramethoxydisiloxane, 1,1,1,3,5,5,5,-heptamethyltrisiloxane, 3-(heptafluoropropyl)trimethysiloxane, octamethyltrisiloxane, octamethyltetrasiloxane, octamethylcyclotetrasiloxane, decamethyltetrasiloxane, decamethylcyclopentasiloxane, dodecamethylpentasiloxane, and dodecamethylcyclohexasiloxane, and combination of two or more thereof.

The coating composition typically comprises about 1 to about 99% by weight of solvent, based on the total weight of the coating composition. Preferably, the coating composition comprises 10 to about 99% by weight of solvent. It will be obvious to one skilled in the art that when the coating composition is a solution, more solvent will be used and when the coating composition is a dispersion, less solvent will be used.

### Additives

The coating composition can further comprise one or more additives, for example, the coating composition may comprise additives such as those selected from the group consisting of catalysts, cross-linkers, refractory fillers, non-fluorinated silicones, and combination of two or more thereof. The coating composition can still further comprise an additive such as modified fumed silica, surfactant, fluoropolymer such as polytetrafluoroethylene, wax, fatty acid such as stearic acid, fatty acid salt such as metal stearate, finely dispersed solid such as talc, emulsifier, pH modifier, biocide, corrosion inhibitor, and combination of two or more thereof.

When the solvent is or comprises water, emulsifiers are preferably added. Emulsifiers include surfactants, rheology modifiers and other compounds which are useful for maintaining dispersion of components of the coating composition of this invention. Surfactants include anionic, nonionic, cationic, amphoteric surfactants and mixtures thereof. Emulsifiers include, for example, cross-linked polyacrylates, polyalkylene oxide modified dimethylpolysiloxanes, amino or quaternary ammonium compounds.

When the coating composition comprises one or more additives, the total amount of additives is in the range of 0.001 to 80% by weight, based on the total weight of the coating composition, preferably from 0.05 to 10% by weight.

### Catalysts

The composition may comprise a catalyst. Any material that can catalyze or enhance the curing of the coating composition disclosed above can be used herein as a catalyst. The catalyst may be selected from the group consisting of compounds of titanium, zirconium, and combination thereof. The catalyst may alternatively be selected from the group consisting of a compound or element of Group VIII metals. These alternative catalysts include the element or compounds of platinum, palladium, iron, zinc, rhodium, nickel and tin.

Examples of suitable titanium and zirconium compounds to use as catalysts include, but are not limited to, those expressed by the formula M(OR³)₄ where M is zirconium or titanium and each R³ is independently selected from the group consisting of alkyl, cycloalkyl, alkaryl, and hydrocarbyl radicals having from about 1 to about 30, preferably from about 2 to about 18, and more preferably about 2 to about 12 carbon atoms per radical. Specific examples of titanium and zirconium catalysts include, but are not limited to, zirconium acetate, zirconium propionate, zirconium butyrate, zirconium hexanoate, zirconium 2-ethyl hexanoate, zirconium octoate, tetraethyl zirconate, tetrapropyl zirconate, tetraisopropyl zirconate, tetrabutyl zirconate, titanium acetate, titanium propionate, titanium butyrate, titanium hexanoate, titanium 2-ethyl hexanoate, titanium octoate, tetraethyl titanate, tetrapropyl titanate, tetraisopropyl titanate, tetrabutyl titanate, and combination of two or more thereof. Preferred are tetraethyl titanate, tetrapropyl titanate, tetraisopropyl titanate, tetrabutyl titanate, and combination of two or more thereof. Titanium and zirconate chelates may also be used. Example of titanium chelates include those available from E. I. du Pont de Nemours and Company, such as, for example, titanium bis-ammonium lactate, bis-acetylacetonate titanate, bis-ethyl acetoacetate titanate, bis-triethanolamine titanate, and combination of two or more thereof. These catalysts are commercially available.

Examples of alternative suitable catalysts include, but are not limited to, dibutyltin diacetate, dibutyltin dilaurate, zinc acetate, zinc octoate, and combination of two or more thereof. Alternative catalysts may be used in combination with zirconium and/or titanium catalysts. For example, dibutyltin diacetate can be used independently or in combination with a titanium compound catalyst.

The coating composition typically comprises about 1 to about 5% by weight of catalyst, based on the total weight of the coating composition. Preferably, the coating composition comprises 0.1 to about 1% by weight of catalyst.

### Non-Fluorinated Silicone

The composition of this invention may further comprise a silicone. By “non-fluorinated silicone” it is meant to include silicone resin, silicone gum, silicone fluid, or combination of two or more thereof, which do not have fluorine substituents. Such silicones are known in the art and are generally available commercially, for example, from Dow Corning, Midland, Mich., General Electric Company, Fairfield, Conn. and Clearco Products, Bensalem, Pa. The silicone also can be produced by any methods known to one skilled in the art.

The non-fluorinated silicone can have the structure of {(R⁵₃SiO_{0.5})ₘ(R⁵₂SiO)ₙ(R⁵SiO_{1.5})ₚ(SiO₂)_{q}}ᵣ where each R⁵ is independently selected from the group consisting of hydrogen, a hydrocarbon radical having 1-20 carbon atoms, and combination of two or more thereof. The radicals can include alkyls, alkenyls, and aryls such as methyl, ethyl, propyl, butyl, vinyl, allyl, phenyl, and combination of two or more thereof. The subscripts m, n, p, and q comprise the molar ratio of the units with the sum of m, n, p, and q equal to 1. Subscript r is an integer which provides a non-fluorinated, non-volatile, silicone having molecular weight from 400 to over 100,000. A combination of resins, gums and fluids can also be used.

Other useful non-fluorinated silicones include dialkyl silicone fluids such as dimethyl silicone; aryl silicone fluids such as phenyl silicone; and copolymers of dialkyl silicones and diaryl silicones can also be used in the invention. These silicones are well known to one skilled in the art such as, for example, that disclosed in Kirk-Othmer, Vol. 20, 1982, pages 936-940.

Also suitable as a non-fluorinated silicone is a polyorganosiloxane such as, for example, methoxy-terminated polyalkylsiloxanes, hydroxy-terminated polyorganosiloxane, and combination of two or more thereof. Examples of polyorganosiloxanes include, but are not limited to, polydimethylsiloxane, polymethylhydrogensiloxane, polysilsesquioxane, polytrimethylsiloxane, polydimethylcyclosiloxane, which can be methoxy-terminated or hydroxyl-terminated, or both. Combination of two or more polyorganosiloxanes may be used.

Each non-fluorinated silicone may also contain functional groups such as non-fluorine halide, amine, hydroxy, epoxy, carbinol, carboxylate, acetoxy, alkoxy, acrylate, and combination of two or more thereof. Preferably the functional group, if present, is an alkoxy group. Preferred alkoxy groups are methoxy and ethoxy. The molecular weight can be in the range of from about 500 to about 1,000,000.

One or more non-fluorinated silicone can be used in the coating composition in the range of from about 0.01 to about 20% by weight, based on the total weight of the coating composition, preferably from about 0.05 to about 5% on the same weight basis.

### Cross-Linker

The coating composition may further comprise a crosslinker. Crosslinkers are capable of reacting with functional groups of polymers to chemically bond one polymer to another forming a branching complex. In comparison with fluorinated and non-fluorinated silicones, cross-linkers generally have lower molecular weights and have more functional groups per unit weight. For the purposes of this invention, a “cross-linker” is a silane or siloxane that is capable of chemically reacting with a functional group, such as the vinyl group of the fluorosilicone or amine in a silicone, as to form a solid, rigid compound. Crosslinkers are commercially available and can also be synthesized by those skilled in the art. For example, crosslinkers can have structures of (R¹)₃SiO[Si(R¹)₂O]ₐ[SiH(R¹)O]_{b}Si(R¹)₃ or (R¹)₃SiO[Si(R¹)(R²Rf)O]ₐ[SiH(R¹)O]_{b}Si(R¹)₃ where a and b each can independently be 1-100. R¹, R² and Rf are as defined above.

Each of the crosslinkers disclosed above can be used in the composition in the range of from about 0.001 to about 10% relative to the total weight of the composition, preferably from about 0.01 to about 1%.

### Refractory Fillers

The coating can further comprise a refractory filler. Examples of refractory fillers include boron nitride, mica, quartz, silicon hexaboride, alumina and carbon whiskers and combination thereof. Preferably, the refractory filler is boron nitride. The refractory filler makes the coating harder, more wear resistant and provides lubricity.

Refractory filler can be used in the coating composition in the range of from about 1 to about 30% by weight, based on the total weight of the coating composition, preferably from about 5 to about 20% on the same weight basis.

### Process

This invention is a process for producing a substrate having a surface which is resistant to alkaline starch, which comprises applying a coating composition to the surface, said composition comprising a fluorosilicone and a solvent. Preferably, as a first or preliminary step, the process comprises cleaning a surface of the substrate. Subsequently, the process comprises applying the coating composition to the cleaned surface. Preferably, the coating composition is applied to produce a thin, continuous film coating on the surface. Optionally the process further comprising a step of curing the composition applied to the surface of the substrate.

The composition can be produced by any means known to one skilled in the art such as, for example, by combining solvent, fluorosilicone, and one or more of the optional additives specified hereinabove and mixing. The optional additive(s) may be selected from the group consisting of catalysts, cross-linkers, refractory fillers, silicones, and combination of two or more thereof. The optional additive(s) may alternatively, or additionally be selected from the group consisting of modified fumed silica, surfactants, fluoropolymers, waxes, fatty acids, fatty acid salts, finely dispersed solids, emulsifiers, biocides, corrosion inhibitors, and combination of two or more thereof.

Combining solvent, fluorosilicone, and optional additives can be carried out by any means known to one skilled in the art. For example, solvent, fluorosilicone, and any additives may be combined simultaneously or sequentially, in any order and mixed together at any suitable temperature, such as, from about 0° C. to about 200° C. Pressure may be added to accommodate the temperature. Mixing should be for a sufficient period of time to effect the production of the coating composition, generally, from about 0.5 minute to about 10 minutes.

Prior to applying the coating composition, a cleaning step may be performed. The cleaning step comprises contacting the surfaces to be cleaned with a detergent, preferably a strong detergent, as are known by those skilled in the art as typically, although not exclusively, as having a pH above 9, or even having a pH of above 10. Preferably, the detergent is dissolved in water, and most preferably the detergent is dissolved in warm or hot water. The detergent can be any of a number of commercially available strong detergents, such as, for example, SIMPLE GREEN All Purpose Cleaner, available from Sunshine Makers, Inc., Huntington Harbour, Calif. Depending on the condition of the substrates and surfaces to be cleaned, cleaning with a detergent may comprise scrubbing, such as with a stiff bristled brush. After cleaning with detergent, the substrates and surfaces are rinsed with water. Alternatively, cleaning may comprise low or high-pressure water washing of the substrate surfaces. Cleaning may alternatively, or further comprise contacting the components with an oil-solubilizing solvent, such as an alcohol. After cleaning and preferably rinsing if a detergent or oil-solubilizing solvent were used in the cleaning step, the surfaces are rinsed with water and they may be dried, for example, allowing to sit until water or solvent has evaporated or wiping with a cloth.

The coating composition may be applied to the surface of the substrate by any means known to one skilled in the art such as, for example, spraying, brushing, wiping, dipping, and combination of two or more thereof.

When the substrate is a corrugator roll, care should be taken to ensure the rolls are completely coated. Preferably, a thicker coating should be applied to the ends of the rolls that are more susceptible to building up of starch.

Curing can be carried out by any means known to one skilled in the art such as curing at ambient temperature such as from about 25° C. to about 200° C. under a pressure that accommodates the temperature range such as, for example, atmospheric pressure for about one second to about 2 hours. Generally, curing is carried out at the temperature and pressure at which the molding is being carried out.

In a particular embodiment of the process of this invention, there is provided an improved process for producing a corrugated paper on a paper corrugator, which comprises passing a first flat sheet of paper into a nip formed by two corrugator rolls rotating in a mesh to form a series of parallel flutes (corrugations) in the sheet to produce a corrugated medium, applying an alkaline starch-based adhesive to the outer ridges of the flutes of the corrugated medium, and bonding one or both sides of the corrugated medium to a second or a second and a third flat sheet to produce corrugated paper, wherein the improvement comprises applying a coating composition which comprises a fluorosilicone and a solvent to the surface of the corrugator rolls prior to passing the first flat sheet into the nip.

Also disclosed, is a substrate comprising a surface or a portion of the surface coated with a composition. The substrate and composition are as disclosed above.

The process of this invention may be repeated. That is, while the present invention provides an improvement in resistant to alkaline starch, e.g., relative to coating compositions lacking a fluorosilicone, after prolonged exposure to alkaline starch, especially at elevated temperatures, the surface of the coated substrate may be compromised. By “compromised”, it is meant to indicate any portion of coating composition that is not uniform, is missing, is removed, is worn through, is chipped, or is rubbed off. For such compromised surfaces, re-application can be accomplished in-situ by applying the coating composition to the surface where the coating has been removed, worn, chipped, etc. Any spot of compromised coating on the substrate is typically cleaned, as described hereinabove, and the coating composition is then re-applied and allowed to cure. Re-application of the coating composition can be by any means known to those skilled in the art including brushing, spraying, wiping, dipping and combination of two or more thereof. The reapplied coating is allowed to cure prior to use. It will be recognized that re-application of the coating composition can occur without the need to remove all of the existing coating prior to re-application. Reapplication of the coating composition can occur while the substrate is still affixed to a machine. Thus, down time and costs associated with removing the substrate are reduced.

### EXAMPLES

### Alkaline Starch-Based Adhesive

A starch adhesive slurry comprising alkaline starch-based adhesive was used in the following examples. This slurry was prepared by mixing corn starch adhesive (2 g, available from EMD Chemicals Inc., Gibbstown, N.J.), water (12.84 g) and sodium hydroxide solution (1N, 0.28 g, available from VWR, West Chester, Pa.).

### Example 1

A coating composition of this invention was prepared by mixing heptane (18.97 g, available from VWR, West Chester, Pa.), a fluorosilicone-containing composition comprising dimethyl methyl perfluorobutylethyl methyl vinyl siloxane copolymer (1.02 g, SYL-OFF release coating Q2-7785, available from Dow Corning, Midland, Mich.), and methyl(perfluorobutylethyl) methyl hydrogen siloxane trimethylsiloxy terminated, cross-linker (0.043 g, SYL-OFF release coating Q2-7560, available from Dow Corning, Midland, Mich.). The resulting coating composition was a solution comprising a fluorosilicone. The coating composition was applied to a carbon steel plate in 3 light coats by spraying at room temperature (73° F., 23° C.) and allowed to cure by solvent evaporation. The temperature of the carbon steel plate was then raised to 350° F. (176° C.). A drop of starch adhesive slurry was placed on steel plate and allowed to dry. The dried starch adhesive was easily removed. A second drop of starch adhesive was added to the hot plate on the same spot as the first and was allowed to dry for 45 minutes. This second drop was easily removed. A third drop of starch adhesive was added to the same spot and was compressed with a tongue depressor. After removing tongue depressor, the dried starch adhesive was easily removed.

### Example 2

A coating composition was prepared by mixing heptane (18.97 g, available from VWR, West Chester, Pa.), the fluorosilicone composition used in Example 1 (1.02 g), the cross-linker used in Example 1 (0.043 g), and boron nitride powder (2.0 g, available from Alfa Aesar, Ward Hill, Mass.). The coating composition was a dispersion of boron nitride in the fluorosilicone solution. The coating composition was applied to a carbon steel plate in 3 light coats by spraying at room temperature (73° F., 23° C.) and allowed to cure. The temperature of the carbon steel plate was then raised to 350° F. (176° C.). A drop of starch adhesive slurry was placed on steel plate and allowed to dry. The dried starch adhesive was easily removed. A second drop of starch adhesive was added to the hot plate on the same spot as the first and was allowed to dry for 45 minutes. This second drop was easily removed. A third drop of starch adhesive was added to the same spot and was compressed with a tongue depressor. After removing tongue depressor, the dried starch adhesive was easily removed.

### Example 3

This example demonstrates the use of a coating composition comprising a fluorosilicone, crosslinker and twice amount of boron nitride as used in Example 2. A coating composition was prepared by mixing heptane (18.97 g, available from VWR, West Chester, Pa.), the fluorosilicone composition used in Examples 1 and 2 (1.02 g), the cross-linker used in Examples 1 and 2 (0.043 g) and boron nitride powder (4.0 g). The coating composition was a dispersion of boron nitride in the fluorosilicone solution. The coating composition was applied to a carbon steel plate in 3 light coats by spraying at room temperature (73° F., 23° C.) and allowed to cure. The temperature of the carbon steel plate was then raised to 350° F. (176° C.). A drop of starch adhesive slurry was placed on steel plate and allowed to dry. The dried starch adhesive was easily removed. A second drop of starch adhesive was added to the hot plate on the same spot as the first and was allowed to dry for 45 minutes. This second drop was easily removed. A third drop of starch adhesive was added to the same spot and was compressed with a tongue depressor. After removing tongue depressor, the dried starch adhesive was easily removed.

### Comparative Example A

A non-fluorosilicone coating composition (Trasys 2224, available from E. I. du Pont de Nemours & Co., Wilmington, Del.), was applied to a carbon steel plate in 3 light coats by spraying at room temperature (73° F., 23° C.) and allowed to cure. The temperature of the carbon steel plate was then raised to 350° F. (176° C.). A drop of starch adhesive slurry was placed on steel plate and allowed to dry. The dried starch adhesive was removed from the plate and the starch adhesive slurry removed some of the silicone coating. A second drop of starch adhesive was added to the hot plate on the same spot as the first and was allowed to dry for 45 minutes. This second drop was removed and a visible spot of the coating was noticed removed. A third drop of starch adhesive was added to the same spot and was compressed with a tongue depressor. Starch adhesive stuck to the plate and could not be removed.

### Example 4

This example shows the coating composition can be used as an aqueous emulsion. A coating composition was prepared by first dissolving tetra-n-butyl titanate (0.2 g, available from E. I. du Pont de Nemours and Company, Wilmington, Del.), a non-fluorinated silicone comprising dimethyl silicone polymer with phenyl silsesquioxanes (80%), toluene (1%) (1 g, GE SR 355 silicone resin, available from GE Silicones, Waterford, N.Y.), and the fluorosilicone composition used in Example 1 (5 g) in methylisobutylketone (10 g, available from VWR, West Chester, Pa.). SILWET L7622 surfactant (1 g, available from GE Silicones, Waterford, N.Y.) was then added to the solution as an emulsifier. The solution which contained the SILWET surfactant was then added to a solution of triethanolamine (1.2 g, available from VWR, West Chester, Pa.) and water (41.5 g) to produce a dispersion. This dispersion was then added to a solution containing CARBOPOL EZ3 rheology modifier (0.06 g, available from BF Goodrich performance Materials, Cleveland, Ohio), PEMULIN 1622 polymeric emulsifier as a co-emulsifier (0.03 g, available from Lubrizol Advanced Materials, Inc, Wickliffe, Ohio), and water (40 g) to produce an aqueous dispersion coating composition. This composition was sprayed onto a carbon steel plate heated to 350° F. (176° C.) and allowed to cure. A drop of starch adhesive slurry was placed onto coated plate and allowed to dry. Starch adhesive was easily removed. A second drop of starch adhesive slurry was placed onto the plate and allowed to dry. The steel plate was turned vertically and with slight shaking, the dried starch adhesive fell off the plate.

### Example 5

The process of Example 4 was repeated using diisobutylketone as solvent. A coating composition was prepared by first dissolving tetra-n-butyl titanate (0.2 g), GE SR 355 silicone resin (1 g) and the fluorosilicone composition used in Example 1 (5 g) in diisobutylketone (10 g). SILWET L7622 surfactant (1 g) was then added to the solution as an emulsifier. The solution containing emulsifier was then added to a solution of triethanolamine (1.2 g) and water (41.5 g) to produce a dispersion. This dispersion was then added to a solution containing CARBOPOL EZ3 rheology modifier as an emulsifier (0.06 g), PEMULIN 1622 polymeric emulsifier (0.03 g), and water (40 g) to produce an aqueous dispersion coating composition. This composition was sprayed onto a carbon steel plate heated to 350° F. (176° C.) and allowed to cure. A drop of starch adhesive slurry was placed onto the coated plate and allowed to dry. Starch adhesive was easily removed. The steel plate was turned vertically and the dried starch adhesive fell off the plate with no shaking.

### Example 6

A coating composition was prepared by mixing pentyl propionate (9.4 g, available from Acros Organics, Morris Plains, N.J.), the silicone used in Example 4 (0.1 g, GE SR 355 silicone resin), the fluorosilicone composition used in Example 1 (0.5 g), and titanium bis-ammonium lactate, (0.02 g, TYZOR LA organic titanate, available from E. I. du Pont de Nemours and Company, Wilmington, Del.). The coating composition was sprayed onto a carbon steel plate room temperature (73° F., 23° C.). The plate was then heated to 350° F. (176° C.) and allowed to cure. The coating was hard and released starch adhesive well when starch adhesive slurry was placed on the plate.

### Example 7

The coating composition of Example 6 (2 g) was added to water (8 g) to produce a coating composition in the form of an aqueous dispersion. The coating composition was sprayed onto a carbon steel plate at 350° F. (176° C.) and allowed to cure. The coating was hard and released starch adhesive well when starch adhesive slurry was placed on the plate.

What is claimed is:

1. A process for producing a substrate having a surface which is resistant to alkaline starch, comprising applying a coating composition which comprises a fluorosilicone and a solvent to the surface.

2. The process of claim 1 further comprising curing the coating.

3. The process of claim 1 or 2 wherein the substrate is one or more components of a paper machine.

4. The process of claim 3 wherein the paper machine is a paper corrugator.

5. The process of claim 4 wherein the one or more components are selected from the group consisting of corrugating rolls, paper rolls, drum dryer rolls, pressure rolls, conduits, and hot plates.

6. The process of claim 1 wherein the composition comprises 0.5 to 10% fluorosilicone, by weight, based on the total weight of the composition.

7. The process of claim 6 wherein the composition comprises 1 to 5% fluorosilicone, by weight, based on the total weight of the composition.

8. The process of claim 1 wherein the coating composition further comprises an additive selected from the group consisting of catalyst, cross-linker, refractory filler, non-fluorinated silicone, and combination of two or more thereof.

9. The process of claim 1 wherein the coating composition further comprises a cross-linker.

10. The process of claim 1 wherein the coating composition further comprises an additive selected from the group consisting of modified fumed silica, surfactant, fluoropolymer, wax, fatty acid, fatty acid salt, finely dispersed solid, emulsifier, pH modifier, biocide, corrosion inhibitor, and combination of two or more thereof.

11. The process of claim 1 wherein the coating composition further comprises boron nitride.

12. The process of claim 1 wherein the coating composition further comprises phenyl silsesquioxane resin or methyl silicone resin or phenyl silicone resin or a combination of two or more thereof.

13. The process of claim 1 wherein the solvent is selected from the group consisting of ketone, ester, alkane, volatile siloxane, and combination of two or more thereof.

14. The process of claim 1 wherein the coating composition further comprises a catalyst.

15. The process of claim 14 wherein the catalyst is selected from the group consisting of compounds of titanium, zirconium, and combination thereof.

16. The process of claim 14 wherein the catalyst is selected from the group consisting of a compound or element of Group VIII metals, wherein the Group VII metal is further selected from the group consisting of platinum, palladium, iron, zinc, rhodium, nickel and tin.

17. The process of claim 1 wherein the coating composition comprises water.

18. The process of claim 17 wherein the coating composition further comprises an emulsifier.

19. An improved process for producing a corrugated paper on a paper corrugator comprising passing a first flat sheet of paper into a nip formed by two corrugator rolls rotating in a mesh to form a series of parallel flutes (corrugations) in the sheet to produce a corrugated medium, applying an alkaline starch-based adhesive to the outer ridges of the flutes in the corrugated medium, and bonding one or both sides of the corrugated sheet to a second or to a second and third flat sheet to produce corrugated paper, wherein the improvement comprises applying a coating composition which comprises a fluorosilicone and a solvent to the surface of the corrugator rolls prior to passing the first flat sheet into the nip.

20. The process of claim 19 wherein the coating composition further comprises an additive selected from the group consisting of catalyst, cross-linker, refractory filler, non-fluorinated silicone, and combination of two or more thereof.

21. The process of claim 19 wherein the coating composition further comprises an additive selected from the group consisting of modified fumed silica, surfactant, fluoropolymer, wax, fatty acid, fatty acid salt, finely dispersed solid, emulsifier, pH modifier, biocide, corrosion inhibitor, and combination of two or more thereof.
